(19) United States
(12) Patent Application Publication
(10) Pub. No.: US 2025/0137906 A1
(43) Pub. Date: May 1, 2025

(54) DETECTION SYSTEM AND SAMPLE PROCESSING INSTRUMENT FOR NANOPARTICLES

(71) Applicants: Beckman Coulter, Inc., Brea, CA (US); Beckman Coulter Biotechnology (Suzhou) Co., Ltd., Jiangsu (CN)

(72) Inventors: Liang SHI, Suzhou, Jiangsu (CN); Wenlei FANG, Suzhou, Jiangsu (CN); Linqun TANG, Suzhou, Jiangsu (CN); Jianfei ZHENG, Suzhou, Jiangsu (CN); Jingzhang WU, Suzhou, Jiangsu (CN); Qi GU, Suzhou, Jiangsu (CN); Juntao YUAN, Suzhou, Jiangsu (CN); Evgenia KIM, Palmetto Bay, FL (US); Yongqin CHEN, Suzhou, Jiangsu (CN); George BRITTAIN, Miami, FL (US)

(73) Assignees: Beckman Coulter, Inc., Brea, CA (US); Beckman Coulter Biotechnology (Suzhou) Co., Ltd., Jiangsu (CN)

(21) Appl. No.: 18/685,164

(22) PCT Filed: Jun. 17, 2022
(86) PCT No.: PCT/CN2022/099413

§ 371 Date: Feb. 20, 2024

(30) Foreign Application Priority Data
Aug. 31, 2021 (CN) 202111017822.7

(51) Int. Cl. G01N 15/1409; G01N 15/00; G01N 15/14; G01N 15/1434

(52) U.S. Cl. CPC G01N 15/1409; G01N 15/1434; G01N 15/1459; G01N 2015/0038; G01N 2015/1452

(57) ABSTRACT

A detection system and a sample processing instrument for nanoparticles are provided. The detection system includes a light emitting unit and a light collection unit. The light emitting unit is configured to emit a light beam and project the light beam onto a nanoparticle to be detected. The light collection unit is configured to collect light beams from the nanoparticle so as to analyze the nanoparticles according to the collected light beams. The light emitting unit includes multiple light sources and a focusing lens, and the light beams emitted by the multiple light sources are focused through the focusing lens on a same detection position through which the nanoparticle is to pass.

### FIELD

The present disclosure relates to a detection system of a sample processing instrument such as a flow cytometry sorter/analyzer, and in particular to a detection system for nanoparticles and a sample processing instrument including the detection system.

### BACKGROUND

This section provides background information related to the present disclosure which is not necessarily prior art.

A sample processing instrument is usually configured to analyze a liquid sample that includes small suspended particles (e.g., biological particles, non-biological particles) or cells and/or configured to sort the particles or cells therein. The conventional sample processing instrument is suitable for detecting a sample having particles or cells with a large size, often greater than 1000 nm. The conventional sample processing instrument has a detection system including multiple light sources which focus on different detection positions in a detection channel of the flow cell, so that crosstalk can be prevented or reduced. Due to the relatively large size of the conventionally analyzed particles, such as cells, an optical signal of the particles easily captured, so that the sample may flow through the flow cell at a high rate. Therefore, a time delay is short and a requirement for liquid flow stability is low.

However, detection systems of conventional sample processing instruments are not well-suited for detecting very small particles, such as biological nanoparticles (e.g., extracellular vesicles) or non-biological nanoparticles (e.g., nanobeads). For example, many conventional sample processing instruments are simply not sensitive enough to detect or discern optical signals from these very small particles, resulting in an inaccurate detection result.

### SUMMARY

This section provides a general summary of the disclosure and is not a comprehensive disclosure of its full scope or all of its features.

In view of the above problems of the conventional detection system of a sample processing instrument, an object of the present disclosure is to provide a detection system and a sample processing instrument for nanoparticles with high precision.

According to an aspect of the present disclosure, a detection system for nanoparticles is provided. The detection system includes a light emitting unit and a light collection unit. The light emitting unit is configured to emit a light beam and project the light beam onto a nanoparticle to be detected. The light collection unit is configured to collect light beams from the nanoparticle so as to analyze the nanoparticles according to the collected light beams. The light emitting unit includes multiple light sources and a focusing lens, and the light beams emitted by the multiple light sources are focused through the focusing lens on a same detection position through which the nanoparticle is to pass.

In some examples according to the present disclosure, the light beams emitted by the multiple light sources have wavelengths different from each other, and a dichroic mirror is provided between each light source and the focusing lens. Dichroic mirrors can combine beams of different wavelengths.

In some examples according to the present disclosure, the light beams emitted by the multiple light sources are reflected or transmitted to be collinear beams via the dichroic mirrors.

In some examples according to the present disclosure, a long-focus lens (e.g., a spherical or aspheric lens) lens is provided between each light source and the corresponding dichroic mirror.

In some examples according to the present disclosure, the dichroic mirrors and the long-focus lens are adjustable so as to adjust a position of a focus point of the light beam in the direction perpendicular to the optical axis.

In some examples according to the present disclosure, a beam expander is provided between each light source and the corresponding long-focus lens, and the beam expander is configured according to a required size of a spot of the light beam, and further configured to adjust a waist (focus) position of the light beam in a direction along the optical axis.

In some examples according to the present disclosure, the beam expander is composed of two optical parts, and a distance between the two optical parts is adjustable. Each of the two optical parts is selected from one of a convex lens, a convex lens group, a concave lens and a concave lens group.

In some examples according to the present disclosure, the light collection unit includes a side collection part. The side collection part includes an optical focusing lens group, collection fiber, a beam splitter, a first wavelength division multiplexer and a second wavelength division multiplexer. The optical focusing lens group includes a concave mirror and an aspheric lens and is configured to focus a light beam emitted from the nanoparticle. The optical focusing lens group focuses the light beam into the collection fiber. The beam splitter is configured to divide the incident light beam from the collection fiber into a side scattered light beam and a fluorescent light beam. The first wavelength division multiplexer is configured to receive the side scattered light beam from the beam splitter via a first fiber. The second wavelength division multiplexer is configured to receive the fluorescent light beam from the beam splitter via a second fiber. Other example configurations are also described herein.

In some examples according to the present disclosure, the collection fiber has a diameter different from diameters of the first and second fibers.

In some examples according to the present disclosure, the diameter of the collection fiber is smaller than the diameters of the first and second fibers.

In some examples according to the present disclosure, the first wavelength division multiplexer includes multiple optical transmission paths corresponding to multiple optical channels, and a first filter and a second filter for each of the multiple optical channels. For each optical channel, the first filter and the second filter are arranged at a certain distance from each other along the optical transmission path of the optical channel in a non-parallel manner.

In some examples according to the present disclosure, the second wavelength division multiplexer includes a single filter for each optical channel.

In some examples according to the present disclosure, the light collection unit further includes a forward collection part. The forward collection part includes a concave mirror and a forward detector. The concave mirror has an ellipsoidal surface and a reflective material coated on the ellipsoidal surface to reflect and focus the forward scattered light beam from the nanoparticle. The forward detector receives the light beam reflected from the concave mirror.

According to another aspect of the present disclosure, a sample processing instrument for nanoparticles is provided. The sample processing instrument includes a fluidic system, a flow cell, and the detection system. The fluidic system is configured to transport various processing and cleaning fluids. The flow cell is provided with a sample needle for supplying a sample containing nanoparticles therein. Sheath fluid supplied by the fluidic system wraps the sample in the flow cell to obtain a stable sample flow. The detection system is as described above and is configured to detect nanoparticles in a sample flowing through the flow cell.

In some examples according to the present disclosure, the flow cell is provided with a bubble discharge passage through which bubbles in fluid in the flow cell are discharged.

In some examples according to the present disclosure, the flow cell is provided with at least two bubble discharge passages at different levels.

In some examples according to the present disclosure, two bubble discharge passages of the at least two bubble discharge passages are located near a bottom and a top of a fluid converging chamber of the flow cell, respectively.

In some examples according to the present disclosure, the fluidic system includes a pump and a switching device. The pump includes a cylinder and a piston reciprocating in the cylinder. The switching device is configured to selectively fluidly communicate the pump to the sample needle or a sample source.

In some examples according to the present disclosure, the switching device includes a three-way valve including a first port connected to the pump and a second port connected to the sample needle and a third port connected to the sample source. The three-way valve is switched between a first position where the pump is allowed to communicate with the sample needle and a second position where the pump is allowed to communicate with the sample source.

In some examples according to the present disclosure, the switching device includes a three-way connector and a two-way valve. The three-way connector includes a first port connected to the pump, a second port connected to the sample needle and a third port connected to the sample source. The two-way valve is arranged between the third port and the sample source, and is switched between an opened position where the third port is allowed to communicate with the sample source and a closed position where the communication between the third port and the sample source is interrupted.

In some examples according to the present disclosure, the sample processing instrument is adapted to detect particles ranging from 40 nanometers to 1000 nanometers. Particularly, the sample processing instrument is suitable for detecting particles ranging from 40 nanometers to 200 nanometers.

In some examples according to the present disclosure, the fluidic system is configured to supply sheath fluid at a flow rate of 0.5 mL/min to 1.5 mL/min, and supply the sample at a flow rate of 1 uL/min to 6 uL/min.

In some examples according to the present disclosure, a filter with precision ranging from 5 nm to 20 nm is provided for the sheath fluid in the fluidic system.

The above and other purposes, features and advantages of the present disclosure are fully understood through the detailed description and the drawings given for describing rather than limiting the present disclosure.

### BRIEF DESCRIPTION OF THE DRAWINGS

The features and advantages of one or more embodiments of the present disclosure are easily to be understood trough the following description with reference to the drawings. In the drawings:

FIG. 1 is a perspective schematic view of a flow cell of a flow cytometry analyzer;

FIG. 2 is a longitudinal section schematic view of the flow cell shown in FIG. 1;

FIG. 3 is a schematic view of a detection system according to an embodiment of the present disclosure;

FIG. 4 is a schematic view of an optical path of the detection system shown in FIG. 3;

FIG. 5 is a schematic view showing adjustment of a waist position of the light beam by a beam expander according to an embodiment of the present disclosure;

FIG. 6 is a perspective schematic view of a forward mirror according to an embodiment of the present disclosure;

FIG. 7 is a schematic view of a part of a fluidic system according to an embodiment of the present disclosure;

FIG. 8 is a schematic view of a variation of the fluidic system shown in FIG. 7;

FIG. 9 is a longitudinal section schematic view of a flow cell of a sample processing instrument according to another embodiment of the present disclosure;

FIG. 10A shows a particle in the sample irradiated at the same time by multiple light sources of the detection system according to the present disclosure;

FIG. 10B shows a particle in the sample irradiated at different times by multiple light sources of a conventional detection system;

FIGS. 11A and 11B show the spot of light beam emitted from the laser diode;

FIG. 12 is a schematic view of a variation of a detection system showing a beam splitter and two wavelength division multiplexers; and

FIG. 13 is a schematic view of another variation of a detection system showing a beam splitter and two wavelength division multiplexers.

### DETAILED DESCRIPTION OF EMBODIMENTS

The present disclosure will be described in detail below through exemplary embodiments with reference to the drawings. In the several drawings, like reference numerals represent like components and modules. The following detailed description of the present disclosure is only for illustration rather than for limitation to the application or use of the present disclosure. The embodiments described in the specification are not exhaustive and are only some of many possible embodiments. Exemplary embodiments may be implemented in many different forms and should not be understood to limit the scope of the present disclosure. In some exemplary embodiments, a well-known process, a known device structure, and a well-known technology may not be described in detail.

For the purpose of illustration, a flow cytometry analyzer is described as an example sample processing unit. However, it should be understood that the present disclosure is not limited to the illustrated flow cytometry analyzer, but may be applied to a flow cytometry analyzer with other structure or other types of sample processing instrument. In particular, the invention is applied to various types of sample processing instrument for detecting, sorting, or otherwise processing nanoparticles.

The nanoparticles described herein refer to nanoscale particles. For example, the particles may have a size (for example, a diameter, a maximum size, or an average size) less than or equal to 1000 nm (nanometer), especially, a size ranging from 40 nm to 200 nm. The nanoparticles may be biological nanoparticles (e.g., extracellular vesicles) or non-biological nanoparticles (e.g., nanobeads).

The flow cytometry analyzer includes a flow cell, a fluid system including pumps and valves, an optical detection system and a sample analysis system. The fluid system transports a sample and sheath fluid to the flow cell through the pumps and the valves. In the flow cell, the sheath fluid wraps the sample to cause the nanoparticles contained in the sample to linearly flow through the flow cell in a single row, so as to collect signals of the nanoparticles one by one. When the nanoparticles pass through a detection area, the nanoparticles are irradiated by a light source (usually a laser light source) of the optical detection system. This irradiation may cause particles within the sample to scatter light (e.g., generating side scattered signals or forward scattered signals). In some cases, the sample may include fluorescent particles (e.g., nanoparticles of interest that are conjugated or otherwise associated with fluorophores, nanoparticles of interest that are themselves fluorescent) that may emit fluorescence signals in response to the irradiation. These signals are collected by the optical detection system. The collected signals of the nanoparticles are processed and analyzed by the sample analysis system to obtain information of the detected nanoparticles.

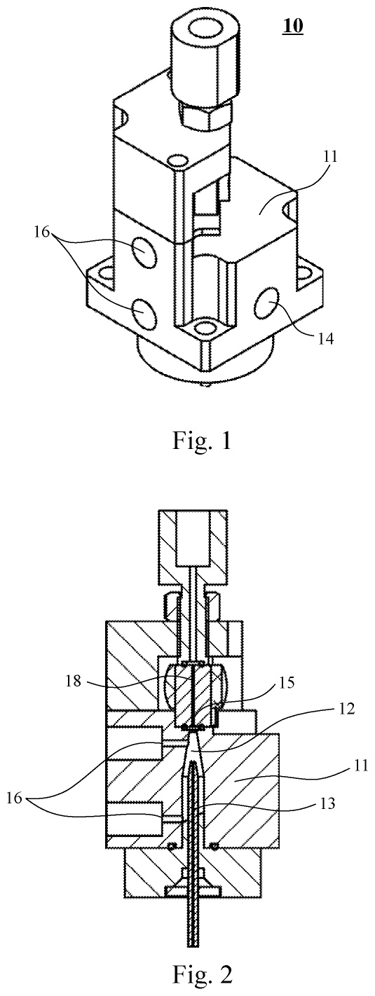

The flow cell is a key component of the flow cytometry analyzer. FIG. 1 is a perspective schematic view of a flow cell 10 of an example flow cytometry analyzer, and FIG. 2 is a longitudinal section schematic view of the flow cell 10 shown in FIG. 1. As shown in FIGS. 1 and 2, the flow cell 10 includes a body 11, and a sample needle 13 and a cuvette 15 that are fitted in the body 11. A fluid converging chamber 12 and one or more sheath channels 14 (only one shown in FIG. 1) are formed in the body 11. The sheath fluid is transported to the fluid converging chamber 12 through the sheath channel 14, and the sample is transported to the fluid converging chamber 12 through the sample needle 13. A detection channel 18 is formed in the cuvette 15. The cuvette 15 may be made of a transparent material. Optical detection is performed on the nanoparticles within the sample when the sample and sheath fluid are flowing through the detection channel 18. That is, the cuvette 15 forms the detection area for the nanoparticles.

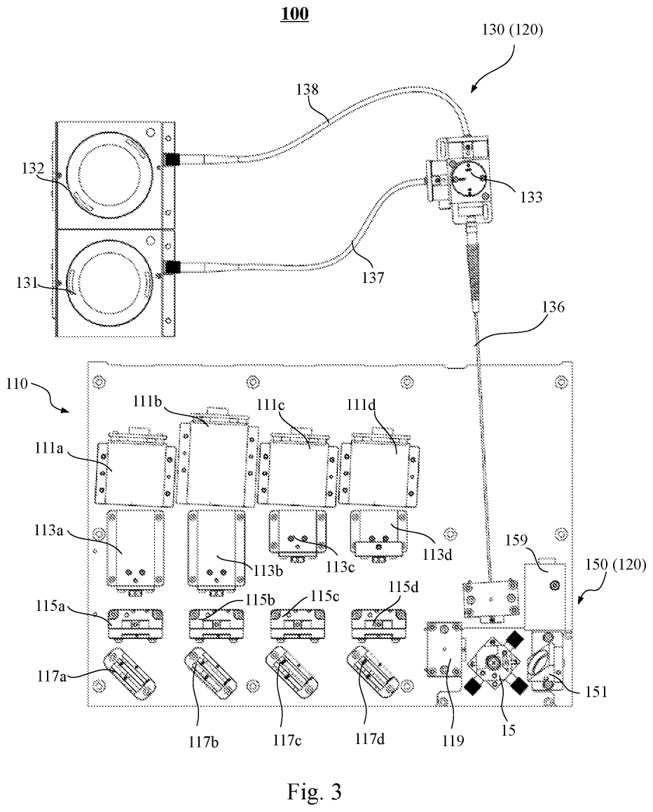

The detection system according to the embodiments of the present disclosure will be described below with reference to FIGS. 3 to 6.

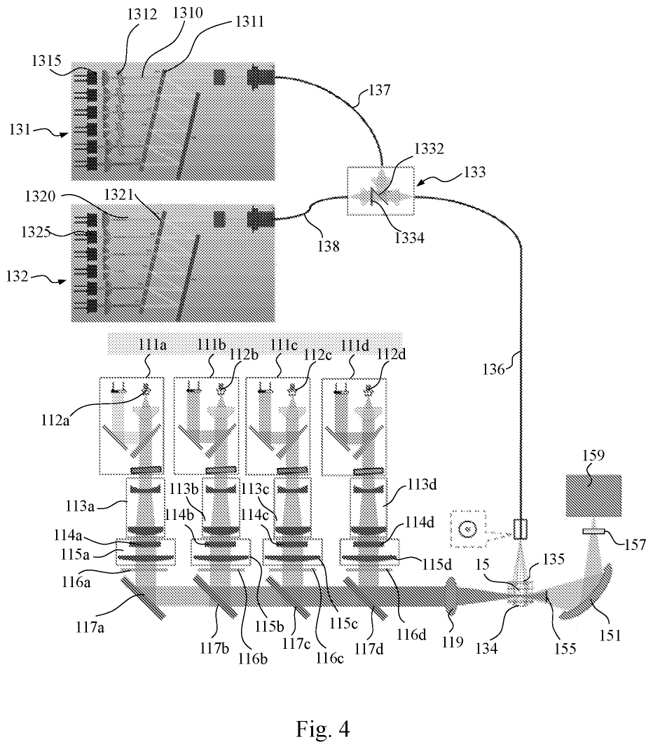

FIG. 3 is a schematic view of a detection system 100 according to an embodiment of the present disclosure, and FIG. 4 is a schematic view of an optical path of the detection system 100 shown in FIG. 3. Referring to FIGS. 3 and 4, the detection system 100 includes a light emitting unit 110 and a light collection unit 120 (including a forward scatter unit and/or a side scatter unit). The light emitting unit 110 is configured to emit a light beam and project the light beam onto a nanoparticle flowing through the detection channel 18 of the cuvette 15. The light collection unit 120 is configured to collect light scattered or emitted from the nanoparticle so as to analyze the nanoparticles based on the collected light.

The light emitting unit 110 includes four light sources 111a to 111d such as lasers. The four light sources 111a to 111d are configured to emit light beams with different wavelengths, for example, 405 nm, 488 nm, 561 nm and 638 nm for the lasers. In the example shown, the four light sources 111a to 111d are arranged in parallel. It should be understood that the number, the type and the arrangement of the light sources are not limited to the example shown, and may be changed as needed. For example, the system may include three, five, six, or any other suitable number of light sources.

The light emitting unit 110 further includes a focusing lens 119. The light beams emitted by the light sources 111a to 111d pass through the focusing lens 119 and then are focused on a same detection position in the detection channel 18 of the cuvette 15. The detection position may be referred to as a focus point or an interrogation point.

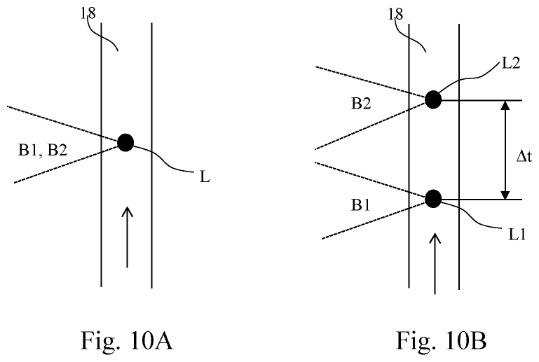

As shown in FIG. 10A, the detection system according to the present disclosure controls the light beams B1 and B2 of multiple light sources to focus on the same interrogation point L, that is, a nanoparticle within the sample wrapped by the sheath fluid is irradiated by the light beams B1 and B2 at the same time when passing through the interrogation point L in the detection channel 18. Therefore, it is possible to basically eliminate the problem of detection time delay occurred in the prior art as shown in FIG. 10B.

FIG. 10B shows the detection time delay occurred in a conventional detection system. As shown in FIG. 10B, the conventional detection system includes two light sources emitting respective light beams B1 and B2. The light beams B1 and B2 focus on different points L1 and L2 in the detection channel 18 of the cuvette 15. When the sample flows upwardly through the detection channel 18, a particle contained in the sample firstly reaches the point L1 where it is illuminated by the light beam B1 and scatters or emits light for detection. Then, the particle further goes upwardly to the point L2 where it is illuminated by the light beam B2 and scatters or emits light for detection. As such, the light scattered or emitted from the particle will of course be shifted in time by At. Conventional systems may account for this shift by simply time shifting by At such that the system can associate measurements of scattered/emitted light taken at points L1 and L2 with the same particle.

However, it is desired to have a much decreased flow rate of the sample to ensure capture of extremely small nanoparticles when the nanoparticles are detected. Decreasing the flow rate introduced increased flow variability, such that it may not be possible to rely on a constant At to time shift measurements. If the conventional detection system as shown in FIG. 10B is used to detect the nanoparticles at the decreased flow rate, since there are significant fluctuations in the flow of the sample, At will be very large and varied.

Compared with the conventional detection system, the detection system according to the present disclosure can eliminate the detection time delay by using an optical system with collinear beams configured to irradiate a sample at the same place at the same time. As a result, there is no need to time shift the measurements, such that the problem of varying At caused by reduced flow rates is no longer an issue. Accordingly, the velocity of the fluid flowing in the detection channel 18 can be reduced, which is particularly beneficial for the detection of nanoparticles.

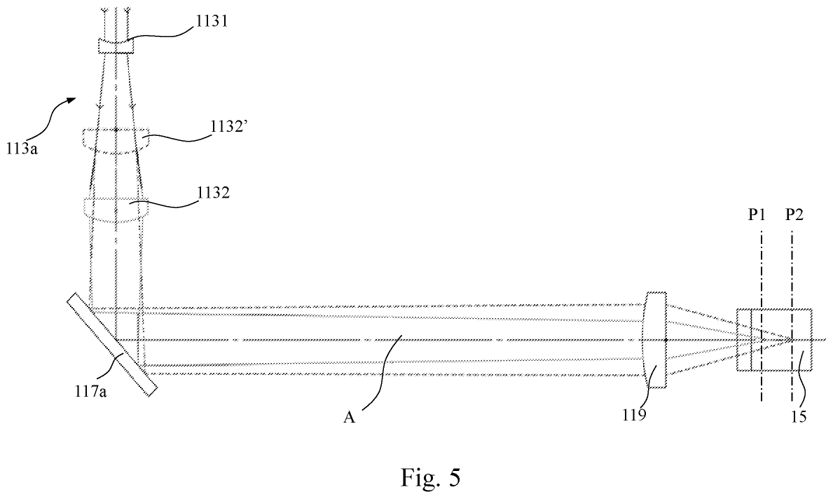

Dichroic mirrors 117a to 117d may be arranged between the focusing lens 119 and the respective light sources 111a to 111d. Each of the dichroic mirrors 117a to 117d is configured to reflect the light beam of the corresponding one of the light sources 111a to 111d and transmit the light beams of the other light sources. The dichroic mirrors 117a to 117d may be selected and configured according to the wavelengths of the light beams emitted by the respective light sources 111a to 111d. For example, the dichroic mirror 117b may be configured to reflect light of the wavelength emitted by the light source 111b and configured to transmit light of the wavelength emitted by the light source 111a; the dichroic mirror 117c may be configured to reflect light of the wavelength emitted by the light source 111c and configured to transmit light of the wavelengths emitted by the light sources 111a and 111b; and the dichroic mirror 117d may be configured to reflect light of the wavelength emitted by the light source 111d and configured to transmit light of the wavelengths emitted by the light sources 111a, 111b, and 111c. The light beams emitted by the light sources 111a to 111d are reflected by or transmitted through the dichroic mirrors 117a to 117d to form collinear beams. The collinear beams mean having a same optical axis (optical axis A as shown in FIG. 5). The collinear beams are useful to realize a confocal point of multiple light sources, i.e., focusing on the same detection position. The dichroic mirrors 117a to 117d are adjustable in their positions or orientations, so as to adjust the position of the focus point of the beams, especially, the position on a plane perpendicular to the optical axis. Although not illustrated in the figures, in some embodiments, the beams may be configures such that they are not collinear, but are convergent beams that still focus on the same point. That is, they may not all have the same optical axis, but they are all configured to focus on a single point in the sample channel of the cuvette 15.

Lenses 115a to 115d may be arranged between the respective light sources 111a to 111d and the respective dichroic mirrors 117a to 117d. Lenses 115a to 115d may be long-focus lens. In some examples, the lenses 115a to 115d may be spherical lenses. In other examples, the lenses 115a to 115d may be aspheric lenses. Each of the lenses 115a to 115d can convert light beams into parallel beams. In the shown example, each of the lenses 115a to 115d is in the form of planoconvex lens with a flat surface and a convex surface opposite to each other. For example, the convex surface of the planoconvex lens may have a focal length of 2400 mm. The lenses 115a to 115d are adjustable in their positions or orientations, so as to adjust the position of the focus point of the light beams, especially, the position on the plane perpendicular to the optical axis. Generally, the dichroic mirrors 117a to 117d can be used to roughly adjust the position of the focus point of the light beams, whereas the lenses 115a to 115d can be used to finely adjust the position of the focus point of the light beams.

It should be understood that the number, the type and the arrangement of the dichroic mirrors and the lenses may be changed as needed, and are not limited to the example illustrated herein as long as the functions described in the present disclosure can be realized. In addition, the dichroic mirrors and the lenses may also be replaced with other optical elements or optical modules with similar functions.

Beam expanders 113a to 113d may be arranged between the respective light sources 111a to 111d and the respective lenses 115a to 115d. Each of the beam expanders 113a to 113d can change a sectional dimension and a divergence angle of a light beam. As such, each of the beam expanders 113a to 113d may be configured according to a desired size of a spot of a light beam.

It is desired to have a light beam irradiated on the nanoparticles, wherein the light beam has a spot size that is smaller than conventional systems. This smaller spot size allows for a more concentrated beam with a high power density so as to increase intensity of the beams, and ultimately the intensity of the optical signals collected from the nanoparticles, thereby greatly improving the efficiency of collecting the optical signals and resulting in high resolution and high sensitivity. For example, the size of the spot may be 3×15 μm, 10×80 μm, or any suitable size between these sizes. The size of the spot may be determined according to the size of the sample core stream as well as the flow fluctuation.

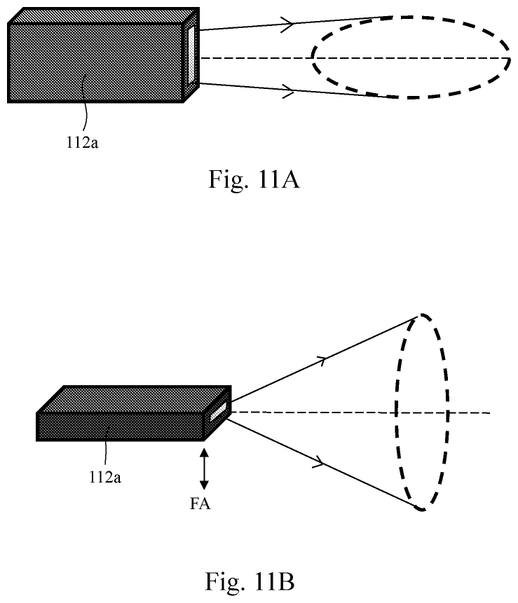

The spot of light beam may be reduced by reorientation of a laser diode of a laser (light source) and provision of a half-wave plate. As shown in FIG. 4, the light sources 111a to 111d in the form of lasers include respective laser diodes 112a to 112d, and half-wave plates 116a to 116d are provided between the dichroic mirrors 117a to 117d and the lenses 115a to 115d respectively. The laser diodes 112a to 112d and the half-wave plates 116a to 116d may be arranged in the same way. For the purpose of illustration, only the laser diode 112a is shown in FIGS. 11A and 11B. Referring to FIG. 11A, the laser diode 112a emits an elliptical spot of light beam. The laser diode 112a in FIG. 11A is oriented in the same way as that of the conventional detection system. The inventor has found that the laser diode 112a may be rotated by 90 degrees to reduce the spot of light beam, as shown in FIG. 11B. This rotation may change a fast axis direction FA from a horizontal direction to a longitudinal direction. Since the laser is linearly polarized, when the laser is rotated by 90 degrees, its polarization direction is also rotated by 90 degrees. The half-wave plate functions to rotate the polarization direction. This is because light scatter is stronger at vertical polarization from small nanoparticles. In an example, the half-wave plate may be made of quartz crystal. When the polarization direction is at an angle θ from a direction of crystal axis, the polarization direction will be rotated by an angle of 2θ through the half-wave plate. For example, if θ=45 degrees, the polarization direction will be rotated by 90 degrees. That is, it is the same as the polarization direction before rotating the laser diode 112a. In this way, the laser spot has a smaller size and an increased energy density, thereby improving the signal-to-noise ratio and increasing the signal strength of the side scattered and fluorescent light.

Cylindrical lens 114a to 114d may be provided between the respective beam expanders 113a to 113d and the respective lens 115a to 115d. By changing the cylindrical lens with different curvatures, it is possible to adjust the horizontal size of the spot of light beam focused within the cuvette 15.

Additionally or alternatively, the power of some or all of the light sources may be increased, compared with the conventional systems. For example, a particular light source of a conventional system may have a power of 30 mW, whereas the same light source of the detection system recited in this disclosure may have an increased power of 50 mW. The increased power of the light source may also improve detection sensitivity. The powers of individual light sources may be determined as actual requirements.

Generally, each of the beam expanders 113a to 113d is formed of a first optical part and a second optical part. In the example shown, each beam expander 113a, 113b, 113c or 113d is formed of a concave lens adjacent to the corresponding light source as the first optical part and a convex lens away from the corresponding light source as the second optical part. It should be understood that each of the beam expanders 113a to 113d is not limited to the example shown, and may be formed of any suitable optical lens or lens group. For example, each of the first optical part and the second optical part is selected from one of a convex lens, a convex lens group, a concave lens and a concave lens group.

For each beam expander, the distance between the first optical part (the concave lens in the shown example) and the second optical part (the convex lens in the shown example) forming the beam expander is adjustable, so as to adjust a waist position (the focus point) of the light beam on the optical axis. FIG. 5 is a schematic view showing adjustment of a waist position of the light beam by the beam expander 113a according to an embodiment of the present disclosure. Adjustment of the waist position of the light beam will be described with reference to FIG. 5 by taking the beam expander 113a as an example.

As shown in FIG. 5, the beam expander 113a is composed of a concave lens 1131 at a location on the optical path that is relatively near to the light source 111a and a convex lens (depicted at two possible positions 1132 and 1132′) at a location on the optical path that is relatively far from the light source 111a (as compared to the concave lens 1131). FIG. 5 illustrates the convex lens at a first position using reference numeral 1132 and further illustrates the same convex lens at a second position using reference numeral 1132′. The convex lens may be moved to one of these two positions or to a position in between these two positions to ultimately alter the beam waist (e.g., within the cuvette 15). For example, in the case of the convex lens 1132 at the first position (drawn in FIG. 5 using solid lines), the light beam passes through the convex lens 1132 and the focusing lens 119 and then is focused at a waist position P1. In the case of the convex lens 1132′ at the second position (drawn in FIG. 5 using dotted lines), the light beam passes through the convex lens 1132′ and the focusing lens 119 and then is focused at a waist position P2. In FIG. 5, the beam waist position P2 is moved to the right along the optical axis A relative to the beam waist position P1. Although not illustrated in FIG. 5, the cuvette 15 includes a channel through it for a sample to flow through the cuvette 15, and position P1 and P2 may be within the channel.

In the example shown in FIG. 5, the concave lens 1131 is fixed, whereas the convex lens 1132 is movable relative to the concave lens 1131. Similarly, in an alternative example not shown, the convex lens 1132 may be fixed, whereas the concave lens 1131 is movable relative to the convex lens 1132. Or, the concave lens 1131 and the convex lens 1132 both are movable towards or away from each other.

Furthermore, the beam expanders 113b to 113d each may be adjusted in a similar way to the beam expander 113a, and thus will not be described in detail herein.

As described above, by adjusting the dichroic mirrors 117a to 117d, the lenses 115a to 115d and the beam expanders 113a to 113d, the individual light beams can be focused at the desired interrogation point, and multiple light beams can be focused at the same interrogation point. It should be understood that the position of the focus point of the light beams may be adjusted by adopting any other optical element or in any other adjustment manner. One or more of these adjustments to these components (the dichroic mirrors, the lenses, the beam expanders) may be made manually, or may be made electronically using a computing device (e.g., a controller) that is associated with one or more actuators coupled to the components.

The light collection unit 120 includes a side collection part 130 and a forward collection part 150. The side collection part 130 serves as the side scatter unit and may be configured to collect side scattered light and fluorescent light scattered or emitted from the nanoparticles in the sample as they are irradiated by the light beams while passing through the cuvette 15. In some examples, the optical axis of light beams collected from the particle by this side collection part 130 may be approximately perpendicular to, or about 90 degrees from, the optical axis A of the light beams that are directed toward the cuvette 15. The forward collection part 150 serves as the forward scatter unit and is configured to collect a forward scattered light from the nanoparticles. In some examples, the optical axis of light beams collected from the particle by this forward collection part 150 may be approximately parallel to, or about 0 degrees from, the optical axis A of the light beams that are directed toward the cuvette 15. The side collection part 130 and the forward collection part 150 are described in further detail below.

The side collection part 130 includes an optical focusing lens group including a concave mirror 134 and an aspheric lens 135, a collection fiber 136, a beam splitter 133, a first wavelength division multiplexer 131 and a second wavelength division multiplexer 132. The concave mirror 134 reflects the scattered light and the fluorescent light that diverge in various directions at the interrogation point. The concave mirror 134 and the aspheric lens 135 focuses the reflected lights on the collection fiber 136, for example, focusing on the same point of the collection fiber 136 as shown in the dotted block in FIG. 4. Specifically, the concave mirror 134 can focus the lights on the fiber. The aspheric lens 135 can make the focal point smaller (reduce the aberration). In order to prevent crosstalk, a beam splitter 133 is arranged to separate the scattered light with high intensity from the fluorescent light with low intensity. The separated scattered light and fluorescent light respectively enter the first wavelength division multiplexer 131 and the second wavelength division multiplexer 132 through the respective fibers. Optical signals with different wavelengths are separated in the first wavelength division multiplexer 131 and the second wavelength division multiplexer 132 for analysis.

It should be noted that the optical focusing lens group may adopt other optical elements or optical element groups as long as the function described in the present disclosure can be realized.

The beam splitter 133 includes a dichroic mirror 1332 and a notch filter 1334. Collected light may be directed into the beam splitter toward the dichroic mirror 1132 by the collection fiber. The collection fiber 136 may be oriented such that the light beam is directed toward the dichroic mirror 1332 at an incident angle of, for example, 45 degrees. The dichroic mirror 1332 reflects the side scattered light coming out of the collection fiber 136. The reflected side scattered light enters the first wavelength division multiplexer 131 through the first fiber 137. The fluorescent light coming out of the collection fiber 136 passes through dichroic mirror 1332. The fluorescent light transmitted from the dichroic mirror 1332 is incident to the notch filter 1334 at an incident angle of 90 degrees and then passes through the notch filter 1334. The fluorescent light enters the second wavelength division multiplexer 132 through the second fiber 138. The filters 1332 and 1334 each have multiple bands according to the confocal design of multiple light sources. In this case, the filters 1332 and 1334 both have 4 bands that blocks 4 laser wavelengths. The number of bands of the filter 1332 or 1334 corresponds to the number of the light sources.

The beam splitter 133 separates the side scattered light with high intensity from the fluorescent light with low intensity, reducing or preventing crosstalk of the side scattered light to the fluorescent light. In addition, by providing the beam splitter, it is possible to separate and transmit multiple light beams into two or more wavelength division multiplexers. Most of the existing wavelength division multiplexers have limited signal channels, for example, six signal channels. In the case of more than six light signals, a single wavelength division multiplexer having six signal channels is insufficient. The use of the existing wavelength division multiplexer may significantly reduce the costs.

It should be understood that the optical elements, the type and the configuration of the beam splitter 133 may be changed as needed, and are not limited to the example shown.

In some examples, referencing FIG. 4, the first wavelength division multiplexer 131 may be configured to receive the side scattered light beams from the beam splitter 133 via the first fiber 137 and to divide optical signals of the side scattered light with different wavelengths from each other. In the first wavelength division multiplexer 131, each optical signal is transmitted along an optical transmission path 1310 corresponding to an optical channel of the optical signal. The first wavelength division multiplexer 131 may include a first filter 1311 and a second filter 1312 for each optical channel. The first filter 1311 and the second filter 1312 may be arranged at a certain distance from each other along the optical transmission path of the optical channel in a non-parallel manner. Crosstalk between side scattered lights can be reduced or prevented by providing the two filters. The first and second filters 1311 and 1312 are not arranged in parallel so as to avoid multiple reflections of light between them and achieve a better optical density. Then, the filtered light enters a light detection element 1315 (e.g., a photodiode, an avalanche photodiode (APD), a photomultiplier tube) for further processing the light.

In this example, the second wavelength division multiplexer 132 may be configured to receive a fluorescent beam from the beam splitter 133 via the second fiber 138 and to divide the optical signals of the fluorescent beam having different wavelengths from each other. In the second wavelength division multiplexer 132, each optical signal is transmitted along an optical transmission path 1320 corresponding to an optical channel of the optical signal. Since the fluorescent signal is weak, the second wavelength division multiplexer 132 may include only a single filter 1321 for each optical channel. Then, the filtered fluorescent light enters a light detection element 1325 (e.g., a photodiode, an avalanche photodiode (APD), a photomultiplier tube) for further processing the light.

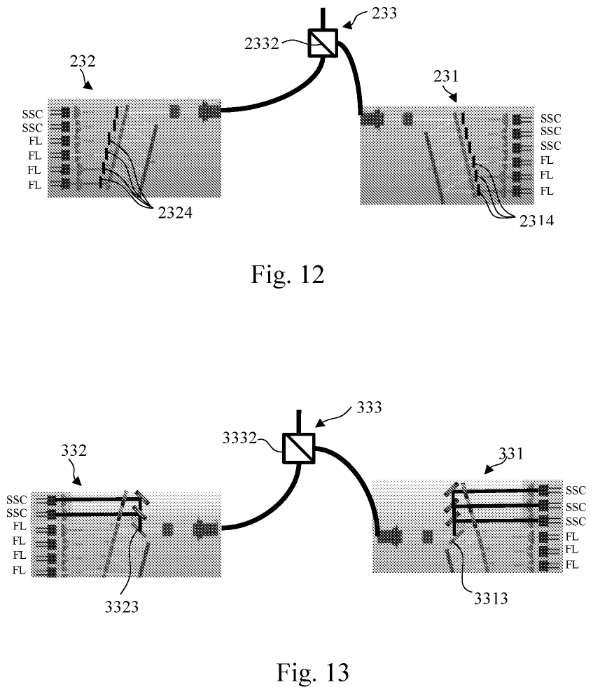

Although the disclosure focuses on this particular configuration of the first and second wavelength division multiplexers, other suitable configurations may be used. For example, in some examples as shown in FIG. 12, the first and second wavelength division multiplexers 231 and 232 include notch filters 2314 and 2324 corresponding to the respective fluorescence channels. Due to the provision of the notch filters 2314 and 2324, the crosstalk of the side scattered light SSC to the fluorescence light FL may be reduced or eliminated. In this case, the beam splitter 233 may only include a dichroic mirror 2332 with no notch filter. In an alternative example as shown in FIG. 13, similarly, the beam splitter 333 may only include a dichroic mirror 3332 with no notch filter. The first and second wavelength division multiplexers 331 and 332 may include dichroic filters 3313 and 3323 for firstly separating the side scattered light SSC from the fluorescence light FL to reduce or eliminate the crosstalk of the side scattered light SSC to the fluorescence light FL, as shown in FIG. 13.

In the side collection part 130, a diameter of the collection fiber 136 may be different from diameters of the first fiber 137 and the second fiber 138 according to the light transmission efficiency. Lenses in the beam splitter may cause aberration, and thus the output light spots may be larger than input of the beam splitter, and the fiber diameters may be selected to account for this. In general, the diameter of the collection fiber 136 is less than diameters of the first fiber 137 and the second fiber 138. For example, the diameter of the collection fiber 136 may be about 0.4 mm, and the diameters of the first fiber 137 and the second fiber 138 may be about 0.6 mm. It should be understood that the diameters of the fibers may be changed as needed and are not limited to the example illustrated in the present disclosure.

The forward collection part 150 includes an obscuration bar 155, a concave mirror 151, a filter 157 and a forward detector 159. The obscuration bar 155 is configured to block a large portion of the light transmitted through the cuvette 15 (e.g., within a central radius of the light emitted from the cuvette toward the concave mirror 151) so as to reduce background noise created by the light beams that go directly through the cuvette. The majority of lights may be blocked so as not to saturate the forward detector. The obscuration bar 155 may be made of anti-reflected material. The concave mirror 151 is configured to reflect a forward scattered beam emitted from the nanoparticles. The filter 157 is configured to allow a light with a high signal-to-noise ratio to pass, and block other lights. For example, the filter 157 may be selected to allow one of the lights emitted from the light sources 111a to 111d and block the other three lights. The forward detector 159 receives the filtered forward scattered light from the blocking filter 157, processes and analyzes the forward scattered light.

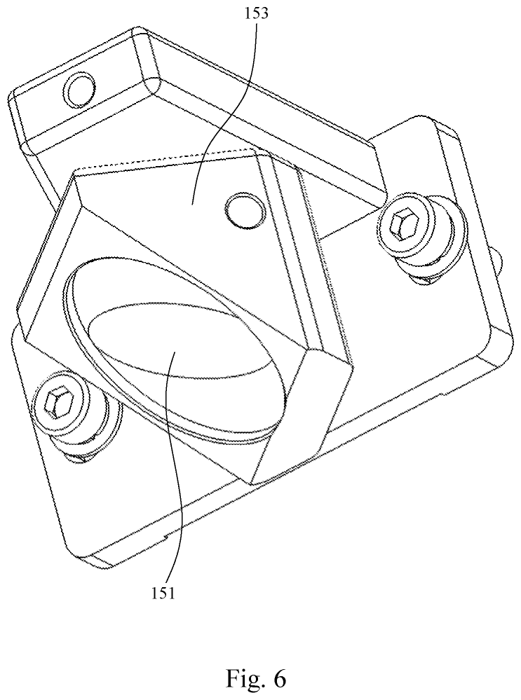

FIG. 6 is a perspective schematic view of a forward mirror (e.g., an elliptical mirror) according to an embodiment of the present disclosure. As shown in FIG. 6, the concave mirror 151 includes an ellipsoidal surface 151 and a reflective material is coated on the ellipsoidal surface 151. The reflective material may be selected to reduce light that may reflect back to cuvette and potentially increase background noise. The reflective material or coating may be of protective aluminum (anti-oxidation coating on aluminum), protective silver (anti-oxidation coating on silver), dielectric film and protective gold (anti-oxidation coating on gold). The reflectivity may reach more than 90% with respect to the light of 350 nm to 700 nm. The concave mirror 151 is carried on a support frame 153. The support frame 153 is adjustable in at least one dimensional direction, so that a position or an angle of the concave mirror 151 can be adjusted. A structure and an installation mode of the support frame 153 may be varied as needed. The reflective material may be a commonly used reflective material coated on an optical element. The forward detector 159 may be an existing forward detector in the sample processing instrument, and thus is not described herein.

The detection system of the sample processing instrument should not be limited to the examples described in the present disclosure or shown in the drawings, and may be varied according to actual detection requirements. For example, an optical element may be replaced, removed, or added according to requirements for detection performance. For example, a half-wave plate may be arranged between each spherical lens and the corresponding dichroic mirror to change a phase difference.

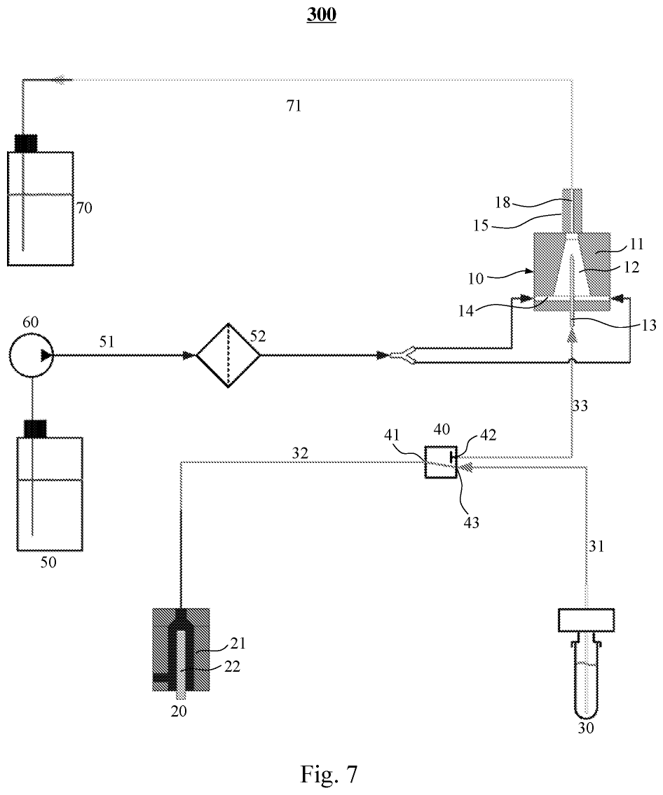

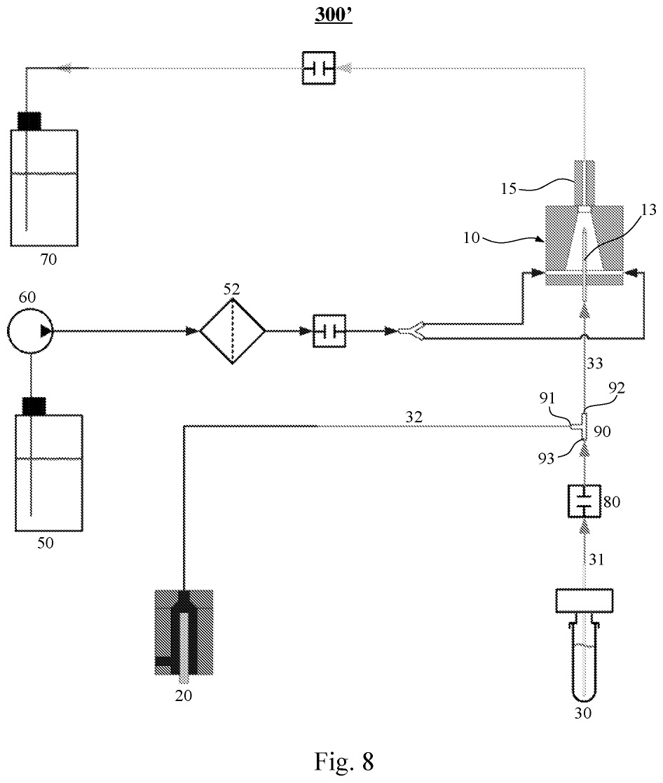

In order to detect the nanoparticles in the sample, it is beneficial to reduce the flow rate of the sample and the sheath fluid, as compared to conventional systems. This reduced flow rate allows for longer exposure of the particles within the sample to the light beams directed at the particles, thus allowing for increased light scatter and/or emission from the particles. A reduced flow rate is especially important when the spot sizes of the light beams directed at the particles are relatively small (as compared to conventional systems). Furthermore, a reduced flow rate reduces variations in flow patterns and reduces the robust coefficient of variation (rCV). As explained herein, it may be advantageous in some example systems to reduce the spot sizes of the light beams so as to concentrate the light beams and thereby increase the intensity of the beams so as to allow increased light collection. Thus, the smaller light beam spot size may in many cases require a reduced flow rate to ensure that the target particles receive adequate exposure to the light beams directed at the particles. A fluidic system according to an embodiment of the present disclosure will be described below with reference to FIGS. 7 and 8. It should be noted that FIGS. 7 and 8 only show an improved part of the fluidic system, rather than a complete fluidic system.

Referring to FIG. 7, the fluidic system 300 includes a sheath pipeline 51 for connecting a sheath source 50 to the flow cell 10, sample pipelines 31 to 33 for connecting a sample source 30 to the flow cell 10 (specifically the sample needle 13), a pump 20 arranged in the sample pipelines, a switching device (three-way valve 40 as shown in FIG. 7, or three-way connector 90 and two-way valve 80 as shown in FIG. 8) arranged in the sample pipeline, and a waste pipeline 71 for transporting a waste liquid into a waste container 70.

The pump 20 is configured to draw a sample in the sample source 30 via the sample pipeline 31 into the sample pipeline 32, and to pump the sample in the sample pipeline 32 into the sample needle 13 and the flow cell 10. The pump 20 is a piston pump. Specifically, the pump 20 includes a cylinder 21 and a piston 22 reciprocating in the cylinder 21.

The piston pump can meet requirements of a low flow rate and a small fluid pulsation. The pump 20 usually performs two operations of suctioning fluid (from the sample pipeline 31 to the sample pipeline 32) and pumping fluid (from the sample pipeline 32 to the sample needle 13). The ability of pumping fluid is related to a volume of a chamber containing the fluid in the cylinder 21. Therefore, the pump 20 may have a precise output, in particular, a small output, which facilitates quantitative analysis, for example, volumetric counting or the like. Compared with the piston pump, a peristaltic pump has a larger pulsation and pumps fluid continuously, so that a volume of the output fluid cannot be determined accurately. In some cases, this may not be suitable for quantitative analysis.

In the example shown in FIG. 7, a peristaltic pump 60 is arranged in the sheath pipeline 51, which reduces the cost. However, it should be understood that the peristaltic pump 60 may also be replaced by a piston pump, or any other suitable pump as needed. In the sample processing instrument according to the present disclosure, for example, the pumps may be controlled to supply sheath fluid at a flow rate ranging from 0.5 mL/min to 1.5 mL/min and to supply the sample at a flow rate ranging from 1 uL/min to 6 uL/min.

The switching device is configured to selectively fluidly communicate the pump 20 to the sample needle 13 or the sample source 30. When the pump 20 suctions the sample, the switching device fluidly communicates the pump 20 to the sample source 30. When the pump 20 pumps the sample, the switching device fluidly communicates the pump 20 to the sample needle 13. Therefore, the switching device may be switched between a first position where the pump 20 is allowed to communicate to the sample needle 13 and a second position where the pump 20 is allowed to communicate to the sample source 30.

In the example shown in FIG. 7, the switching device is a three-way valve 40. The three-way valve 40 includes a first port 41 connected to the pump 20, a second port 42 connected to the sample needle, and a third port 43 connected to the sample source. When the three-way valve 40 is in the first position (not shown), the first port 41 is communicated with the second port 42, and is not communicated with the third port 43. At this moment, the pump 20 is allowed to be communicated with the sample needle 13. When the three-way valve 40 is in the second position (as shown in FIG. 7), the first port 41 is communicated with the third port 43, and is not communicated with the second port 42. At this moment, the pump 20 is allowed to be communicated with the sample source 30.

A filter 52 may be provided in the sheath pipeline 51. The filter 52 may be selected according to a size of the particles within the sample to be detected. For example, for a nanoparticle, a filter 52 may be selected with an accuracy ranging from 5 nm to 40 nm, preferably, from 5 nm to 20 nm. By providing the filter 52, foreign substances with a large size can be prevented from being carried in the sheath fluid to cause an inaccurate detection result.

FIG. 8 is a schematic view of a variation of the fluidic system shown in FIG. 7. The fluidic system 300′ shown in FIG. 8 is different from the fluidic system 300 shown in FIG. 7 in the switching device. The switching device in FIG. 8 includes a three-way connector 90 and a two-way valve 80.

The three-way connector 90 includes a first port 91 connected to the pump 20, a second port 92 connected to the sample needle 13, and a third port 93 connected to the sample source 30.

The two-way valve 80 is arranged in the sample pipeline 31 between the third port 93 and the sample source 30 to control on-off state of the sample line 31. The two-way valve 80 is switched between an open position where the third port 93 is allowed to communicate with the sample source 30 and a closed position where the third port 93 does not communicate with the sample source 30. The two-way valve 80 may be referred to as an on-off valve. When the two-way valve 80 is in the open position (not shown), the third port 93 is communicated with the sample source 30. At this moment, the pump 20 is allowed to communicate with the sample needle 13 to suction the sample into the sample pipeline 32. When the two-way valve 80 is in the closed position (as shown in FIG. 8), the third port 93 does not communicate with the sample source 30. At this moment, the pump 20 is allowed to pump the fluid in the sample pipeline 32 to the sample needle 13.

The fluidic system according to the present disclosure should not be limited to the examples described herein and shown in the drawings. As needed, various valves, pumps or other fluid elements may be provided in the various pipelines. For example, a sensor may be provided in the fluidic system to detect an amount of transported fluid. For example, a sensor may be provided for the sample or sheath fluid to sense information about the sample or the sheath fluid, such as a transportation volume and a transportation velocity. For example, a control device including a processor may be provided in the fluidic system. The control device can not only control operations of various fluid elements, but also calculate values of required parameters according to the data detected by the sensor, such as a volume and a velocity of transported fluid.

Bubbles are usually generated when the sheath fluid and the sample flow into the fluid converging chamber 12 of the flow cell 10. The bubbles may change a flow field in the fluid converging chamber 12, resulting in an unstable laminar flow, thereby adversely affecting a detection result of the sample. In order to eliminate the bubbles, a bubble discharge passage 16 is further formed in the body 11 of the flow cell 10. Next, the bubble discharge passage 16 will be described with back reference to FIGS. 1 and 2.

As shown in FIG. 1, the fluid converging chamber 12 has a smooth inner surface and includes a substantially cylindrical section and a conical section, wherein the substantially cylindrical section is smoothly transited to the conical section. The sample and the sheath fluid are converged approximately at the conical section of the fluid converging chamber 12. The sample needle 13 is arranged coaxially with respect to the cylindrical section of the fluid converging chamber 12. A laminar flow of the sheath fluid is formed in an annular space between the sample needle 13 and the body 11.

The smooth inner surface of the fluid converging chamber 12 can reduce possibility that the bubbles accumulate and adhere thereto. Compared with the conventional flow cytometer on the market, the fluid converging chamber 12 has reduced volume and surface area, thereby further reducing possibility that the bubbles adhere on the inner surface of the fluid converging chamber 12. In addition, the reduced volume of the fluid converging chamber 12 increases a flow velocity of the fluid, thereby facilitating removal of the bubbles.

The bubble discharge passage 16 has an end open to the fluid converging chamber 12, and the other end to be attached with a bubble removal device, such as a vacuum pump, to fully discharge the bubbles in the fluid converging chamber 12.

In the example shown in the FIGS. 1 and 2, the body 11 is provided with two bubble discharge passages 16 at different levels. One of the bubble discharge passages 16 is adjacent to the top (or top surface) of the fluid converging chamber 12, and the other of the bubble discharge passages 16 is adjacent to the bottom (or bottom surface) of the fluid converging chamber 12. The bubble discharge passages 16 at different levels can discharge bubbles effectively, thereby improving the accuracy of detecting the particles in the sample.

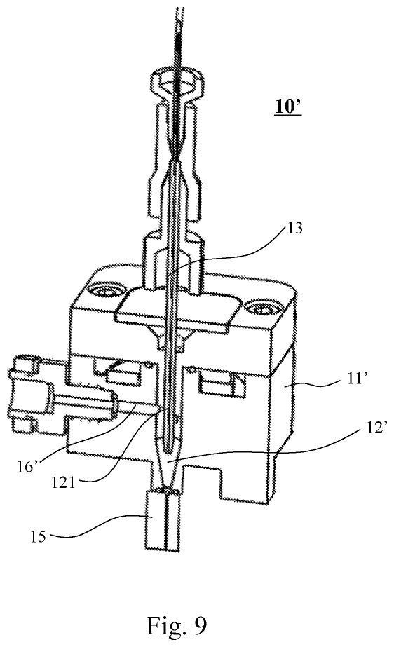

In the examples shown in FIGS. 1 and 2, the sample needle 13 is arranged on the lower side of the flow cell 10. However, it should be understood that the structure of the flow cell is not limited to the structure shown in FIGS. 1 and 2. FIG. 9 shows a flow cell 10′ with another structure. The sample needle 13 is arranged on the upper side of the flow cell 10′. The flow cell 10′ has a fluid converging chamber 12′. A bubble discharge passage 16′ is arranged at the top of the fluid converging chamber 12′ to remove bubbles on the top of the fluid, thereby minimizing an effect of removal of the bubbles on stability of the fluid.

The fluid converging chamber 12′ may include an inclined top surface 121. The top surface 121 may be formed by the body of the flow cell 10′ or formed by a cover plate above the body. The inclined top surface 121 can guide the bubble to be discharged and prevent the bubbles from accumulating in a flow dead area at the top of the fluid converging chamber 12′.

It should be understood that the structure (the number, the position and the like) of the bubble discharge passage may be changed as needed, and is not limited to the examples shown.

Although the present disclosure has been described with reference to exemplary embodiments, it should be understood that the present disclosure is not limited to the embodiments that are described and shown in detail herein. For those skilled in the art, various variations may be made to the exemplary embodiments without departing from the scope defined in the claims. Features in the various embodiments may be combined with each other in a case of no contradiction. Alternatively, a feature in the embodiments may be omitted.

1. A detection system for nanoparticles, comprising: a light emitting unit configured to emit a light beam and project the light beam onto a nanoparticle to be detected; and a light collection unit configured to collect light beams from the nanoparticle so as to analyze the nanoparticles according to the collected light beams; wherein the light emitting unit comprises a plurality of light sources and a focusing lens, and the light beams emitted by the plurality of light sources are focused through the focusing lens on a same detection position through which the nanoparticle is to pass.

2. The detection system according to claim 1, wherein the light beams emitted by the plurality of light sources have wavelengths different from each other, and a dichroic mirror is provided between each light source and the focusing lens.

3. The detection system according to claim 2, wherein the light beams emitted by the plurality of light sources are reflected or transmitted to be collinear beams via the dichroic mirrors.

4. The detection system according to claim 3, wherein a long-focus lens is provided between each light source and the corresponding dichroic mirror.

5. The detection system according to claim 4, wherein the dichroic mirrors and the long-focus lens are adjustable so as to adjust a position of a focus point of the light beam in a direction perpendicular to an optical axis of the light beam directed toward the nanoparticle.

6. The detection system according to claim 5, wherein a beam expander is provided between each light source and the corresponding long-focus lens, and the beam expander is configured according to a required size of a spot of the light beam, and further configured to adjust a waist position of the light beam in a direction along the optical axis.

7. The detection system according to claim 6, wherein the beam expander is composed of two optical parts, a distance between the two optical parts is adjustable, each of the two optical parts is selected from one of a convex lens, a convex lens group, a concave lens and a concave lens group.

8. The detection system according to claim 1, wherein the light collection unit comprises a side collection part comprising: an optical focusing lens group comprising a concave mirror and an aspheric lens and configured to focus a light beam emitted from the nanoparticle; a collection fiber into which the optical focusing lens group focuses the light beam; and a beam splitter configured to divide the incident light beam from the collection fiber into a side scattered light beam and a fluorescent light beam; a first wavelength division multiplexer configured to receive the side scattered light beam from the beam splitter via a first fiber; and a second wavelength division multiplexer configured to receive the fluorescent light beam from the beam splitter via a second fiber.

9. The detection system according to claim 8, wherein the collection fiber has a diameter different from diameters of the first and second fibers.

10. (canceled)

11. The detection system according to claim 8, wherein the first wavelength division multiplexer comprises a plurality of optical transmission paths corresponding to a plurality of optical channels and a first filter and a second filter for each of the plurality of optical channels, and wherein for each optical channel, the first filter and the second filter are arranged at a certain distance from each other along the optical transmission path of the optical channel in a non-parallel manner.

12. (canceled)

13. The detection system according to claim 8, wherein the light collection unit further comprises a forward collection part comprising: a concave mirror having an ellipsoidal surface, wherein a reflective material is coated on the ellipsoidal surface to reflect and focus the forward scattered light beam from the nanoparticle; and a forward detector that receives the light beam reflected from the concave mirror.

14. A sample processing instrument for nanoparticles, comprising: a fluidic system configured to transport various processing and cleaning fluids; a flow cell provided with a sample needle for supplying a sample containing nanoparticles therein, wherein sheath fluid supplied by the fluidic system wraps the sample in the flow cell to obtain a stable sample flow; and the detection system according to claim 1, wherein the detection system is configured to detect nanoparticles in a sample flowing through the flow cell.

15. The sample processing instrument according to claim 14, wherein the flow cell is provided with a bubble discharge passage through which bubbles in fluid in the flow cell are discharged.

16. The sample processing instrument according to claim 15, wherein the flow cell is provided with at least two bubble discharge passages at different levels, wherein two bubble discharge passages of the at least two bubble discharge passages are located at a bottom and a top of a fluid converging chamber of the flow cell, respectively.

17. (canceled)

18. The sample processing instrument according to claim 14, wherein the fluidic system comprises: a pump comprising a cylinder and a piston reciprocating in the cylinder; and a switching device configured to selectively fluidly communicate the pump to the sample needle or a sample source.

19. The sample processing instrument according to claim 18, wherein the switching device comprises a three-way valve comprising a first port connected to the pump and a second port connected to the sample needle and a third port connected to the sample source, and wherein the three-way valve is switched between a first position where the pump is allowed to communicate with the sample needle and a second position where the pump is allowed to communicate with the sample source.

20. The sample processing instrument according to claim 18, wherein the switching device comprises a three-way connector and a two-way valve, the three-way connector comprises a first port connected to the pump, a second port connected to the sample needle and a third port connected to the sample source, the two-way valve is arranged between the third port and the sample source, and is switched between an opened position where the third port is allowed to communicate with the sample source and a closed position where the communication between the third port and the sample source is interrupted.

21. The sample processing instrument according to claim 14, wherein the sample processing instrument is adapted to detect particles ranging from 40 nanometers to 1000 nanometers.

22. The sample processing instrument according to claim 21, wherein the fluidic system is configured to supply sheath fluid at a flow rate of 0.5 mL/min to 1.5 mL/min, and supply the sample at a flow rate of 1 uL/min to 6 uL/min.

23. The sample processing instrument according to claim 21, wherein a filter with precision ranging from 5 nm to 20 nm is provided for the sheath fluid in the fluidic system.
